(19) United States
(12) Patent Application Publication
(10) Pub. No.: US 2010/0214329 A1
(43) Pub. Date: Aug. 26, 2010

(54) PLASMA DISPLAY DEVICE

(76) Inventors: Mitsuhiro Murata, Hyogo (JP); Yusuke Fukui, Osaka (JP); Toshikazu Wakabayashi, Osaka (JP); Hiroshi Asano, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/598,312

(22) PCT Filed: Apr. 14, 2009
(86) PCT No.: PCT/JP2009/001716

§ 371 Date: Oct. 30, 2009

(30) Foreign Application Priority Data
Apr. 18, 2008 (JP) 2008-108595

(51) Int. Cl. G09G 5/10; G09G 3/28

(52) U.S. Cl. 345/691; 345/63

(57) ABSTRACT

The protective layer of the plasma display device is formed of a base protective layer and a particle layer. The base protective layer is a thin film of magnesium oxide containing at least one of magnesium oxide, strontium oxide, calcium oxide, and barium oxide. The particle layer is formed in a manner that magnesium-oxide single-crystal particles, which have a structure surrounded by the specified two-type orientation face formed of (100) and (111) faces or the specified three-type orientation face formed of (100), (110), and (111) faces, are stuck to the base protective layer. The panel driving circuit drives the panel in a manner that one field period is formed of a first subfield group having a plurality of subfields and a second subfield group having a plurality of subfields temporally disposed after the first subfield group. Each subfield of the first subfield group has initializing period Ti, address period Tw for forming wall charge to generate a sustain discharge, and sustain period Ts. On the other hand, each subfield of the second subfield group has address period Tw for erasing wall discharge necessary for generating a sustain discharge and sustain period Ts.

### TECHNICAL FIELD

The present invention relates to a plasma display device as an image display device using a plasma display panel.

### BACKGROUND ART

Among thin-type image display elements, a plasma display panel (hereinafter simply referred to as a panel) has become practical as a large-screen display device from the advantage of high-speed display performance and easy upsizing.

A panel is formed of a front plate and a back plate attached with each other. The front plate has a glass substrate, display electrode pairs of scan electrodes and sustain electrodes disposed on the glass substrate, a dielectric layer formed so as to cover the display electrode pairs, and a protective layer disposed on the dielectric layer. The protective layer not only protects the dielectric layer from ion collision but also promotes generation of a discharge.

The back plate has a glass substrate, data electrodes formed on the glass substrate, a dielectric layer that covers the data electrodes, barrier ribs formed on the dielectric layer, and phosphor layers that emit light in red, green, and blue. The front plate and the back plate are oppositely disposed in a manner that the display electrode pairs and the data electrodes cross each other via a discharge space. The two plates are sealed at the peripheries with low-melting glass. The discharge space is filled with discharge gas including xenon. Discharge cells are formed at positions where the display electrode pairs face the data electrodes.

With a panel structured above, a plasma display device generates a gas discharge selectively in each discharge cell of the panel. Ultraviolet light generated at the discharge excites phosphors to emit light in red, green, and blue. Color image display is thus attained.

As a method for displaying image in a plasma display device with the panel above, a subfield method is generally used. According to the method, one field period is divided into a plurality of subfields, and image display is attained by combination of subfields to be lit and subfields to be unlit.

However, when the control of lit cells and unlit cells is carried out on a subfield basis, a noticeable contour-shaped turbulence in gradation display known as false contours occur when a panel shows dynamic picture image. To suppress the false contours, for example, Patent Literature 1 has a suggestion in which subfields for the discharge cells to be lit are successively disposed, and similarly, subfields for the discharge cells to be unlit are successively disposed. False contours can be suppressed by the method, but a problem of difficulty in smooth gradation display still stays due to a limited level of gradation.

Increase in number of subfields that form one field period provides image display with a smooth gradation. According to the subfield method described above, one field period is formed of a plurality of subfields each of which has an initializing period, an address period, and a sustain period. Gradation display is attained by combination of the subfields to be lit. To increase the number of subfields forming one field period, address operations have to be completed with reliability within a short period. To address above, manufacturers have been working on the development of a panel driven at a high speed and seeking of improved driving method and driving circuits for providing high quality image so as to get best performance from the panel.

Discharge characteristics of a panel largely depend on the characteristics of a protective layer. In particular, the performance of electron emission and charge retention greatly affect the high-speed driving of a panel. To improve above, many studies on the material, structure, and manufacturing method for the protective layer have been made. For example, Patent Literature 2 discloses a plasma display panel with improvements in the panel and the electrode driving circuit. According to the disclosure, the panel has a magnesium oxide layer that exhibits a cathode luminescence emission peak at 200-300 nm. The magnesium oxide layer is generated through gas-phase oxidation of magnesium vapor. Besides, according to the electrode driving circuit above, scan pulses are sequentially applied to one of the display electrode pairs that constitute entire display lines, and at the same time, address pulses suitable for the display lines that undergo the application of scan pulses are applied to the data electrodes.

Recently, in addition to upsizing the screen, there has been growing demand for a high-definition plasma display device with increased lines and high quality in image display; meanwhile, a sufficient number of subfields is necessary for smooth gradation display. Such a demanding situation requires the period for address operations per line to be further shortened. To complete address operations with reliability in a limited period, manufacturers are searching for an advanced panel with more reliable address operations at higher speed than before, a driving method thereof, and a plasma display device with driving circuits controllable the panel and suitable for the method.
[Patent Literature 1] Unexamined Japanese Patent Publication No. H11-305726
[Patent Literature 2] Unexamined Japanese Patent Publication No. 2006-54158

### SUMMARY OF THE INVENTION

The plasma display device of the present invention has a panel and a panel driving circuit. The panel contains a front plate, a back plate disposed opposite to the front plate, and discharge cells formed therebetween. The front plate has a first glass substrate, display electrode pairs formed on the first glass substrate, a dielectric layer formed so as to cover the display electrode pairs, and a protective layer formed on the dielectric layer. The back plate has a second glass substrate and data electrodes formed on the second glass substrate. The discharge cells are formed at which the display electrode pairs face the data electrodes. The panel driving circuit drives the panel in a manner that one field period is temporally divided into a plurality of subfields. The protective layer is formed of a base protective layer and a particle layer. The base protective layer is a thin film of metallic oxide containing at least one of magnesium oxide, strontium oxide, calcium oxide, and barium oxide. The particle layer is formed by sticking single-crystal particles of magnesium oxide to the base protective layer. The single-crystal particles of magnesium oxide have an NaCl crystal structure surrounded by a specified two-type orientation face formed of (100) face and (111) face or a specified three-type orientation face formed of (100) face, (110) face, and (111) face. The panel driving circuit drives the panel in a manner that one field period is formed of a first subfield group having a plurality of subfields and a second subfield group having a plurality of subfields temporally disposed after the first subfield group. In the first subfield group, each subfield has an initializing period for forming wall charge to generate an address discharge, an address period for forming wall charge to generate a sustain discharge, and a sustain period for generating a sustain discharge so that a discharge cell emits light. In the second subfield group, each subfield has an address period for erasing wall charge necessary for generating a sustain discharge and a sustain period for generating a sustain discharge so that a discharge cell emits light.

### BRIEF DESCRIPTION OF THE DRAWINGS

FIG. 1 is a perspective view of the structure of a panel in accordance with an exemplary embodiment of the present invention.

FIG. 2 is a sectional view of the structure of the front plate of the panel.

FIG. 3A shows an example of the shape of single-crystal particles of the panel.

FIG. 3B shows another example of the shape of single-crystal particles of the panel.

FIG. 3C shows yet another example of the shape of single-crystal particles of the panel.

FIG. 3D shows still another example of the shape of single-crystal particles of the panel.

FIG. 4A is a diagram that shows an electron micrograph of a shape of single-crystal particles of magnesium oxide contained in the particle layer of the panel.

FIG. 4B is a diagram that shows an electron micrograph of another shape of single-crystal particles of magnesium oxide contained in the particle layer of the panel.

FIG. 4C is a diagram that shows an electron micrograph of yet another shape of single-crystal particles of magnesium oxide contained in the particle layer of the panel.

FIG. 5A is a diagram that shows another shape of the single-crystal particles in the particle layer of the panel.

FIG. 5B is a diagram that shows yet another shape of the single-crystal particles in the particle layer of the panel.

FIG. 5C is a diagram that shows still another shape of the single-crystal particles in the particle layer of the panel.

FIG. 5D is a diagram that shows still another shape of the single-crystal particles in the particle layer of the panel.

FIG. 5E is a diagram that shows still another shape of the single-crystal particles in the particle layer of the panel.

FIG. 5F is a diagram that shows still another shape of the single-crystal particles in the particle layer of the panel.

FIG. 6 shows an electrode array of the panel.

FIG. 7 is a waveform chart of driving voltage applied to each electrode of the panel.

FIG. 8 is a waveform chart of driving voltage applied to each electrode of the panel.

FIG. 9 is a circuit block diagram of a plasma display device in accordance with the exemplary embodiment of the present invention.

FIG. 10 is a circuit diagram of a scan electrode driving circuit and a sustain electrode driving circuit of the plasma display device.

### REFERENCE MARKS IN THE DRAWINGS

10 panel
20 front plate
21 (first) glass substrate
22 scan electrode
22a, 23a transparent electrode
22b, 23b bus electrode
23 sustain electrode
24 display electrode pair
25 dielectric layer
26 protective layer
26a base protective layer
26b particle layer
27 single-crystal particle
30 back plate
31 (second) glass substrate
32 data electrode
34 barrier rib
35 phosphor layer
41 image signal processing circuit
42 data electrode driving circuit
43 scan electrode driving circuit
44 sustain electrode driving circuit
45 timing generating circuit
50, 80 sustain pulse generating circuit
60 initializing waveform generating circuit
70 scan-pulse generating circuit
100 plasma display device

### DETAILED DESCRIPTION OF THE PREFERRED EMBODIMENTS

Hereinafter, a plasma display device of an exemplary embodiment of the present invention will be described with reference to the accompanying drawings.

### First Exemplary Embodiment

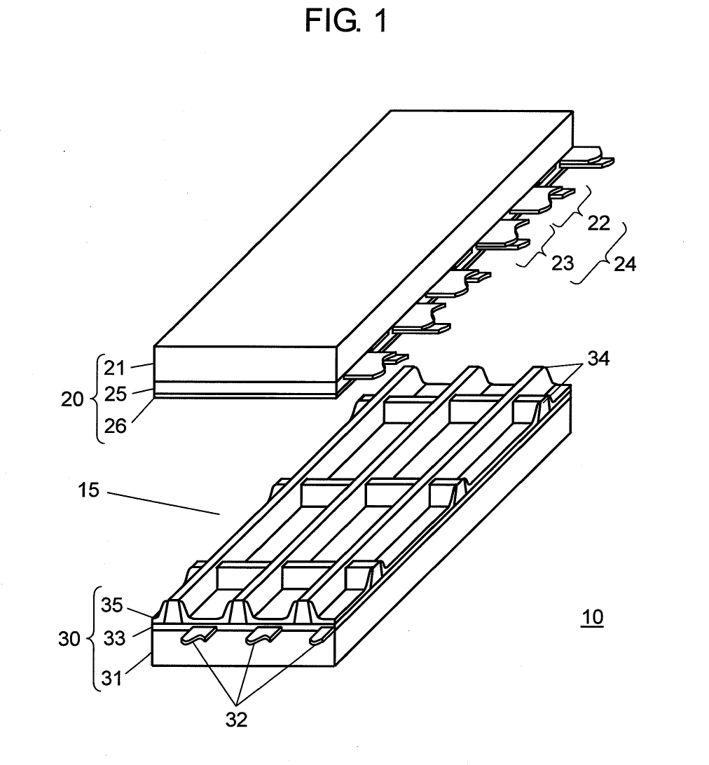

FIG. 1 is a perspective view showing the structure of panel 10 in accordance with the exemplary embodiment of the present invention. Panel 10 has a structure in which front plate 20 is disposed opposite to back plate 30 and the two plates are sealed at the outer peripheries with sealing material of low-melting glass. Discharge space 15 inside panel 10 is filled with discharge gas of, for example, xenon, with a charged pressure of 400 to 600 Torr.

On glass substrate (first glass substrate) 21 of front plate 20, display electrode pairs formed of scan electrodes 22 and sustain electrodes 23 are disposed in parallel, and over which, dielectric layer 25 is formed so as to cover display electrode pairs 24. Protective layer 26 having magnesium oxide as a major component is formed on dielectric layer 25.

On glass substrate (second glass substrate) 31 of back plate 30, a plurality of data electrodes 32 are disposed in parallel in a direction orthogonal to display electrode pairs 24. Data electrodes 32 are covered with dielectric layer 33. Barrier ribs 34 are formed on dielectric layer 33. Phosphor layers 35, which emit light in red, green, and blue by ultraviolet light, are formed on dielectric layer 33 and on the side surface of barrier ribs 34. The discharge cells are formed at intersections of display electrode pairs 24 and data electrodes 32. A set of discharge cells having red, green, and blue phosphor layers 35 forms a pixel for color display. Dielectric layer 33 is not necessarily needed for the panel, and may be omitted from the structure of the panel.

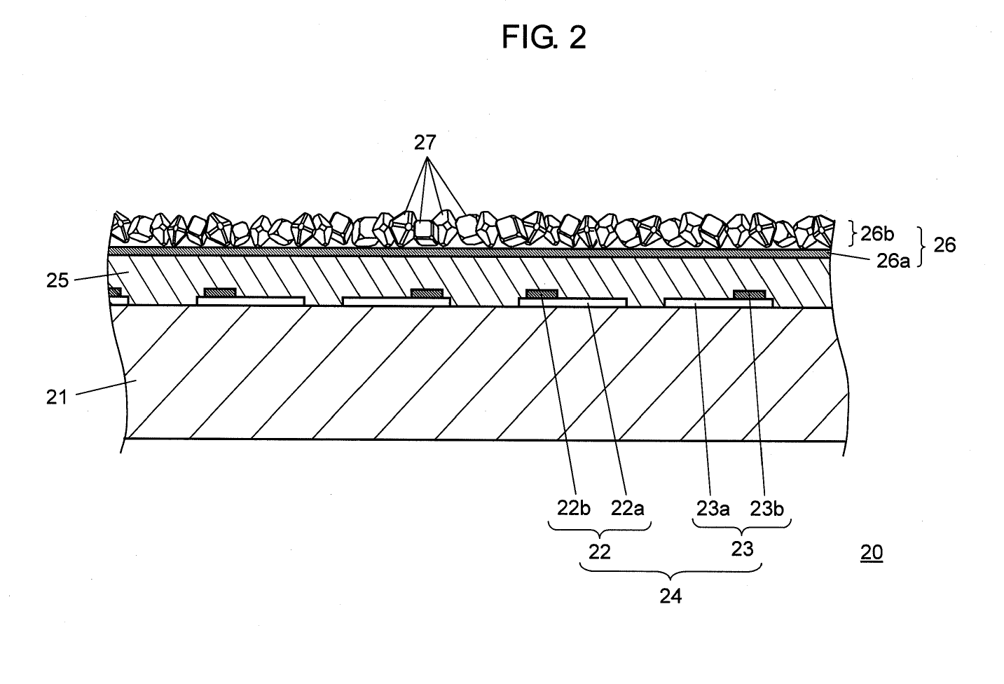

FIG. 2 is a section view showing the structure of front plate 20 of panel 10 in accordance with the exemplary embodiment of the present invention. FIG. 2 is an upside-down view of front plate 20 of FIG. 1. Display electrode pairs 24 formed of scan electrodes 22 and sustain electrodes 23 are formed on glass substrate 21. Each scan electrode 22 is formed of transparent electrode 22a and bus electrode 22b disposed on transparent electrode 22a. Transparent electrodes 22a are made of indium tin oxide, tin oxide, and the like. Similarly, each sustain electrode 23 is formed of transparent electrode 23a and bus electrode 23b disposed on transparent electrode 23a. Bus electrodes 22b, 23b are made of conductive material containing silver as a major component, which allows transparent electrodes 22a, 23a to have conductivity in its lengthwise direction.

Dielectric layer 25 is formed in a manner that low-melting glass containing lead oxide, bismuth oxide, or phosphorus oxide as a major component is applied by, for example, screen printing, die-coating and then fired.

Protective layer 26 is formed on dielectric layer 25. Details on protective layer 26 will be described below. Protective layer 26 protects dielectric layer 25 from ion collision, at the same time, it enhances performance of electron emission and charge retention, which have a great influence on the driving speed of a panel. Protective layer 26 is formed of base protective layer 26a disposed on dielectric layer 25 and particle layer 26b on base protective layer 26a.

Base protective layer 26a is a thin film of magnesium oxide with a thickness of 0.3 to 1.0 μm formed by a thin film forming method such as a vacuum deposition and ion plating. Base protective layer 26a may be made of metal oxide containing at least one of magnesium oxide, strontium oxide, calcium oxide, and barium oxide.

Particle layer 26b is formed in a manner that single-crystal particles 27 of magnesium oxide are stuck onto base protective layer 26a so as to have substantially uniform distribution over the entire surface of protective layer 26a.

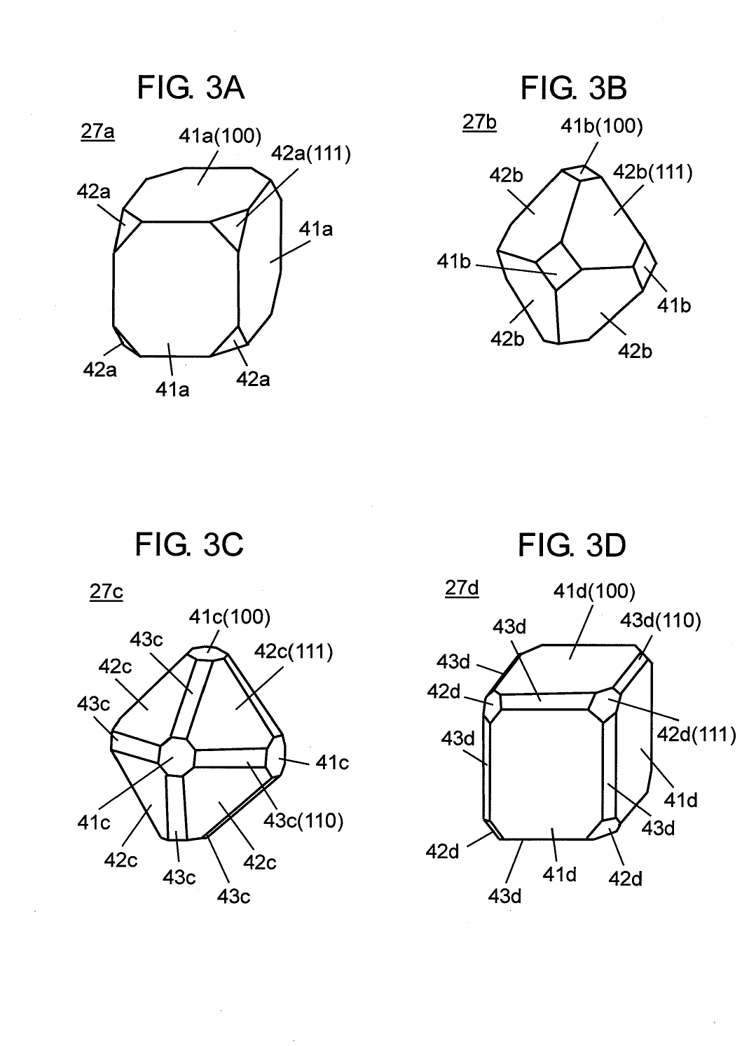

FIG. 3A is a diagram showing an example of the shape of single-crystal particles 27 of panel 10 in accordance with the exemplary embodiment of the present invention. FIG. 3A shows single-crystal particle 27a with a tetradecahedron shape having truncated faces formed by cutting the vertexes of a hexahedron as a fundamental shape. Main faces 41a are (100) faces, and truncated faces 42a are (111) faces. FIG. 3B is a diagram showing another example of the shape of single-crystal particles 27. FIG. 3B shows single-crystal particle 27b with a tetradecahedron shape having truncated faces formed by cutting the vertexes of an octahedron as a fundamental shape. Main faces 42b are (111) faces, and truncated faces 41b are (100) faces. Single-crystal particle 27a and single-crystal particle 27b have an NaCl crystal structure surrounded by the specified two-type orientation face formed of (100) faces and (111) faces.

FIG. 3C is a diagram showing yet another example of the shape of single-crystal particles 27. FIG. 3C shows single-crystal particle 27c with an icosihexahedron shape having rhombic faces formed by cutting the boundaries of (111) faces of the shape of single-crystal particle 27b. Main faces 42c are (111) faces, truncated faces 41c are (100) faces, and rhombic faces 43c are (110) faces. FIG. 3D is a diagram showing yet another example of the shape of single-crystal particles 27. FIG. 3D shows single-crystal particle 27d with an icosihexahedron shape having rhombic faces formed by cutting the edges of adjacent (100) faces of the shape of single-crystal particle 27a. Main faces 41d are (100) faces, truncated faces 42d are (111) faces, and rhombic faces 43d are (110) faces. Single-crystal particle 27c and single-crystal particle 27d have an NaCl crystal structure surrounded by the specified three-type orientation face formed of (100) faces, (110) faces, and (111) faces.

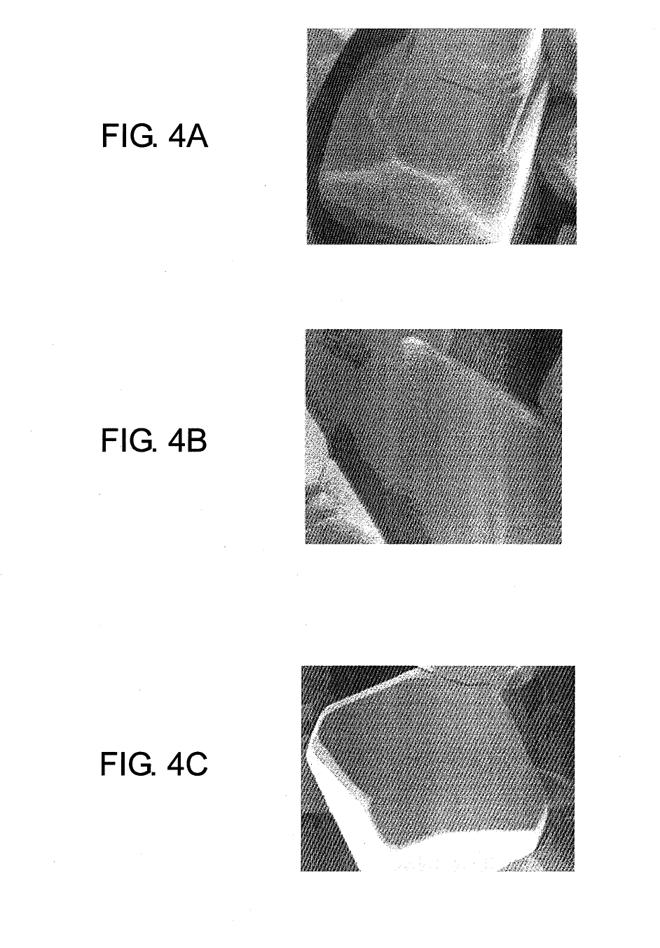

FIG. 4A is a diagram showing an electron micrograph that shows a shape of single-crystal particle 27a of magnesium oxide contained in particle layer 26b of panel 10 in accordance with the exemplary embodiment of the present invention. FIG. 4B is a diagram showing an electron micrograph that shows another shape of single-crystal particle 27b of magnesium oxide contained in particle layer 26b. FIG. 4C is a diagram showing an electron micrograph that shows another shape of single-crystal particle 27c of magnesium oxide contained in particle layer 26b. These diagrams show that particle layer 26b actually contains single-crystal particle 27 of slightly deformed shape.

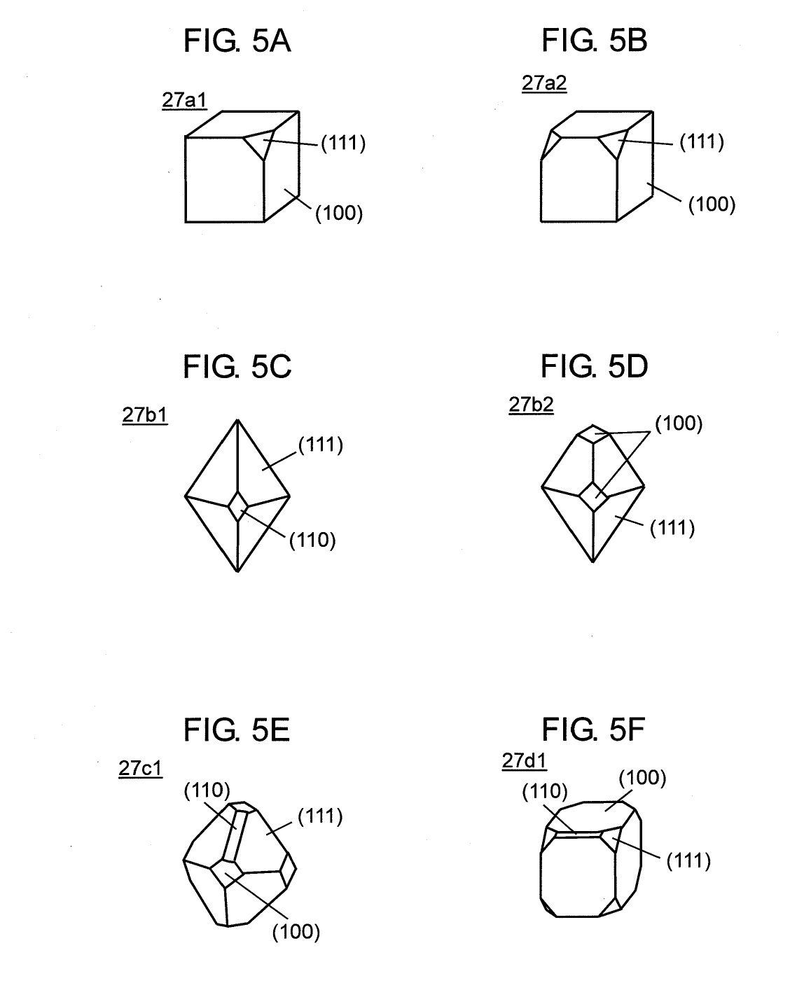

The truncated faces are not formed at all vertexes, and the rhombic faces are not formed at all edges. FIG. 5A is a diagram showing another shape of single-crystal particle 27 contained in particle layer 26b of panel 10 in accordance with the exemplary embodiment of the present invention. FIG. 5A shows a shape having one truncated face as a variation of single-crystal particle 27a. FIG. 5B shows a shape having two truncated faces as a variation of single-crystal particle 27a. FIG. 5C is a diagram showing yet another shape of single-crystal particle 27 contained in particle layer 26b of panel 10 in accordance with the exemplary embodiment of the present invention. FIG. 5C shows a shape having one truncated faces as a variation of single-crystal particle 27b. FIG. 5D shows a shape having two truncated faces as a variation of single-crystal particle 27b. FIG. 5E is a diagram showing still another shape of single-crystal particle 27 contained in particle layer 26b of panel 10 in accordance with the exemplary embodiment of the present invention. FIG. 5E shows a shape having six truncated faces and one rhombic face as a variation of single-crystal particle 27c. FIG. 5F is a diagram showing still another shape of single-crystal particle 27 contained in particle layer 26b of panel 10 in accordance with the exemplary embodiment of the present invention. FIG. 5F shows a shape having eight truncated faces and one rhombic face as a variation of single-crystal particle 27d.

As discussed above, single crystal of magnesium oxide has an NaCl crystal structure of cubic lattice, and has (100), (110), and (111) faces as main orientation faces. Of these orientation faces, (100) face is the densest, and water, hydrocarbon, and impure gas such as carbon dioxide are hardly absorbed into (100) faces in a wide temperature range from low to high. Therefore, employing single-crystal particles 27 mainly having (100) faces allows particle layer 26b to be formed with high performance both in electron emission and charge retention in a wide temperature range.

On the other hand, (111) faces have high electron emission performance especially at normal temperature or higher. Therefore, single-crystal particles 27 mainly having (111) faces are important for panel 10 to be driven at high speed.

A single-crystal particle having an NaCl crystal structure surrounded by the specified two-type orientation face formed of (100) and (111) faces, and a single-crystal particle having an NaCl crystal structure surrounded by the specified three-type orientation face formed of (100), (110), and (111) faces can be produced by a liquid phase method.

Specifically, magnesium hydroxide, which is a precursor of magnesium oxide, is evenly fired in an oxygen-containing atmosphere at high temperatures, as described below.

### (Liquid Phase Method 1)

An aqueous solution of magnesium alkoxide or magnesium acetylacetone of a purity greater than 99.95% is prepared. A little amount of acid is added to the solution and the solution is hydrolyzed. Through the hydrolysis, magnesium hydroxide gel is obtained. The gel is dehydrated by firing in air, by which powder of single-crystal particles 27 is obtained.

### (Liquid Phase Method 2)

An aqueous solution of magnesium nitrate of a purity greater than 99. 95% is prepared. An alkali solution is added to the solution of magnesium nitrate so that magnesium hydroxide is precipitated. After separated from the solution, the precipitate of magnesium hydroxide is dehydrated by firing in air, by which powder of single-crystal particles 27 is obtained.

### (Liquid Phase Method 3)

An aqueous solution of magnesium chloride of a purity greater than 99. 95% is prepared. Calcium hydroxide is added to the solution so that magnesium hydroxide is precipitated. After separated from the solution, the precipitate of magnesium hydroxide is dehydrated by firing in air, by which powder of single-crystal particles 27 is obtained.

Throughout the methods above, the firing temperature should preferably be 700° C. or higher, more preferably, 1000° C. or higher. A single-crystal particle fired at a temperature lower than 700° C. has an immature crystal face, forming a defective structure. According to the experiment, when magnesium hydroxide is fired at a temperature of 700° C. or higher and lower than 1500° C., single-crystal particles 27c and 27d surrounded by the specified three-type orientation face are produced with a high frequency. Further, firing at a temperature of 1500° C. or higher allows (110) faces to be contracted, producing single-crystal particles 27a and 27b surrounded by the specified two-type orientation face with an increased frequency. When the firing temperature is extremely high, oxygen deficiency occurs and defects of magnesium-oxide crystal increase, and hence the firing temperature is preferably set at 1800° C. or lower.

Instead of magnesium hydroxide above, more than one of the followings can be employed for a magnesium-oxide precursor: magnesium alkoxide, magnesium acetylacetone, magnesium nitrate, magnesium chloride, magnesium carbonate, magnesium sulfate, magnesium oxalate, and magnesium acetate. The purity of a magnesium compound as the magnesium-oxide precursor should preferably be greater than 99.95%, more preferably, greater than 99.98%. This is because having a large amount of impurity element, such as alkali metals, boron, silicon, iron, aluminum, in the precursor invites sintering or fusion bonding between the particles in the firing process, resulting in immature growth of crystalline structure.

The liquid phase methods provide single-crystal particles 27 surrounded by the specified two-type orientation face or specified three-type orientation face, and the crystal thereof has less defects. In addition, employing the liquid phase methods allow the powder of single-crystal particles 27 to have relatively small variation in particle diameter.

The crystal of magnesium oxide can be produced by a gas-phase oxidation method, but when magnesium oxide single-crystal particles is produced by the gas-phase oxidation method, (100) faces mainly grow and the other faces are difficult to grow. The disadvantage is considered due to the following reason. When magnesium oxide is produced by the gas-phase oxidation method, for example, metal magnesium is heated to high temperature in a tank filled with inert gas and at the same time, a small amount of oxygen gas is flown into the tank so that metal magnesium is directly oxidized to produce magnesium oxide crystal powder. Therefore, (100) face, which is the densest, mainly grows.

In the liquid phase method of the embodiment, however, magnesium hydroxide as a precursor of magnesium oxide is a hexagonal system component, which is different from the cubic system structure of magnesium oxide. The crystal growth process—where the crystal of magnesium oxide is produced from thermally decomposed magnesium hydroxide—is complicated, but the single crystal of magnesium oxide is produced with the form of hexagonal system maintained, and hence it is considered that (100) faces, (111) faces, and (110) faces are formed as the crystal faces.

Similarly, a magnesium compound such as magnesium alkoxide, magnesium nitrate, magnesium chloride, magnesium carbonate, magnesium sulfate, magnesium oxalate, and magnesium acetate are not cubic system. Therefore, it is considered that, when such a magnesium compound is thermally decomposed as the precursor of magnesium oxide to produce the magnesium oxide crystal, not only (100) faces but also (111), (110) faces are formed while OR₂ group, Cl₂ group, (NO₃)₂ group, CO₃ group, and C₂O₄ group are desorbed.

Besides, the magnesium oxide single-crystal particles produced by the gas-phase oxidation method tend to have a large variation in particle diameter. Therefore, to obtain an identical particle diameter, the manufacturing process of magnesium oxide using the gas-phase oxidation method requires a classifying process.

However, using the liquid phase method of the embodiment provides relatively large single-crystal particles of similar diameters. For example, using the liquid phase method provides crystal particles with a diameter of 0.3 to 2 μm. Therefore, the classifying process for removing micro particles can be omitted. Additionally, using the liquid phase method of the embodiment provides the crystal with a large particle diameter. That is, the magnesium oxide crystal produced by the liquid phase method has a specific surface area smaller than that of the magnesium oxide crystal produce by the gas-phase oxidation method, exhibiting high resistance to adsorption.

As described above, particle layer 26b of the embodiment is formed by sticking single-crystal particles 27 onto base protective layer 26a. Single-crystal particles 27 have an NaCl crystal structure surrounded by the specified two-type orientation face formed of (100) faces and (111) faces or single-crystal particles 27 having an NaCl crystal structure surrounded by the specified three-type orientation face formed of (100) faces, (110) faces, and (111) faces. Such structured particle layer 26b offers stable and high performance both in electron emission and charge retention, allowing panel 10 to be driven at a high speed.

Next will be described a method for driving panel 10 of the embodiment of the present invention.

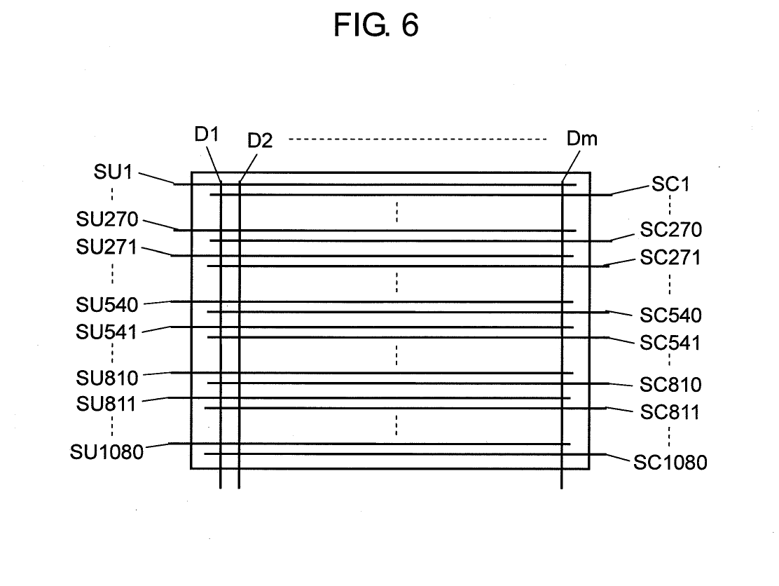

FIG. 6 shows an electrode array on panel 10 in accordance with the embodiment of the present invention. In a row (line) direction, panel 10 has n long scan electrodes SC1 through SCn (corresponding to scan electrodes 22 in FIG. 1) and n long sustain electrodes SU1 through SUn (corresponding to sustain electrodes 23 in FIG. 1). In a column direction, panel 10 has m long data electrodes D1 through Dm (corresponding to data electrodes 32 in FIG. 1). A discharge cell is formed at an intersection of a pair of scan electrode SCi and sustain electrode SUi (where, i is 1 through n) and data electrode Dj (where, j is 1 through m). That is, panel 10 contains m×n discharge cells in the discharge space. For example, m=1920×3=5760 and n=1080. Although the number of display electrode pairs has no specific limitation, the description here will be given on the case of n=1080.

Scan electrodes SC1 through SC1080 and sustain electrodes SU1 through SU1080 form 1080 pairs of display electrodes. The display electrode pairs are divided into a plurality of display electrode pair groups. According to the embodiment, they are divided into four groups in the top-to-down direction of the panel. That is, in the downward order from the electrode pairs disposed at the top of the panel, scan electrodes SC1 through SC270 and sustain electrodes SU1 through SU270 belong to the first display electrode pair group, scan electrodes SC271 through SC540 and sustain electrodes SU271 through SU540 belong to the second display electrode pair group, scan electrodes SC541 through SC810 and sustain electrodes SU541 through SU810 belong to the third display electrode pair group, and scan electrodes SC811 through SC1080 and sustain electrodes SU811 through SU1080 belong to the fourth display electrode pair group.

Next will be described waveforms of driving voltage for driving panel 10. Panel 10 employs a subfield method to provide gradation display. In the subfield method, one field period is divided into a plurality of subfields. Gradation display is attained by light-emitting control of the discharge cells on a subfield basis. According to panel 10 of the embodiment, the subfields are divided into two subfield groups: the first subfield group and the second subfield group.

Each subfield of first subfield group has an initializing period, an address period, and a sustain period. In the initializing period, an initializing discharge is generated to erase the history of wall charge and form wall charge necessary for generating an address discharge. In the address period, an address discharge is generated in a discharge cell to be lit and wall charge is formed for generating a sustain discharge. Such an address operation is hereinafter referred to a “positive-logic” address operation. In the sustain period, sustain pulses corresponding in number to each luminance weight are alternately applied to the display electrode pairs so that a sustain discharge is generated in a discharge cell having undergone the positive-logic address operation and the discharge cell emits light suitable for the luminance weight.

In the subfields of the first subfield group, the control of address discharge on a subfield basis allows a discharge cell to be lit or unlit regardless of whether a sustain discharge is generated or not in other subfields. The driving where light emission control is determined on a subfield basis is hereinafter referred to “random driving”.

On the other hand, each subfield of the second subfield group has an address period and a sustain period only, i.e., they have no initializing period. In the address period, an address discharge is generated in a cell to be unlit, by which wall charge for generating a sustain discharge is erased. Such an address operation is hereinafter referred to a “negative-logic” address operation. In the sustain period, sustain pulses corresponding in number to each luminance weight are alternately applied to the display electrode pairs so that a sustain discharge is generated in a discharge cell where an address discharge has not occurred, and the discharge cell emits light suitable for the luminance weight.

Each subfield of the second subfield group does not have operation for forming wall charge necessary for generating a sustain discharge in the address period, but has operation for erasing wall charge necessary for generating a sustain discharge. Therefore, in a discharge cell with no sustain discharge in the immediately preceding subfield, no sustain discharge occurs before next initializing operation. Besides, in a discharge cell having undergone an address operation, no sustain discharge occurs before next initializing operation.

As a result, the second subfield group has a structure where subfields for a discharge cell to be lit are successively disposed, and at the same time, subfields for a discharge cell to be unlit are successively disposed. Hereinafter, the driving for gradation display—in which discharge cells to be lit and discharge cells to be unlit have a successive arrangement—is simply referred to “successive driving”.

According to the embodiment, one field is divided into 11 subfields (the first SF, the second SF, . . . , the 11th SF), and each subfield has following luminance weight: 8, 4, 2, 1, 16, 20, 26, 32, 40, 48, and 58. The first subfield group, which is formed of the first SF through the fourth SF, employs the random driving with the positive-logic address operation. The second subfield group, which is formed of the fifth SF though the 11th SF, employs the successive driving with the negative-logic address operation. In the first subfield group, the initializing period of the first SF has an all-cell initializing operation for generating an initializing discharge in all the discharge cells, whereas the initializing period of the second SF through the fourth SF has a selective initializing operation for generating an initializing discharge selectively in a discharge cell having undergone a sustain discharge in the immediately preceding subfield.

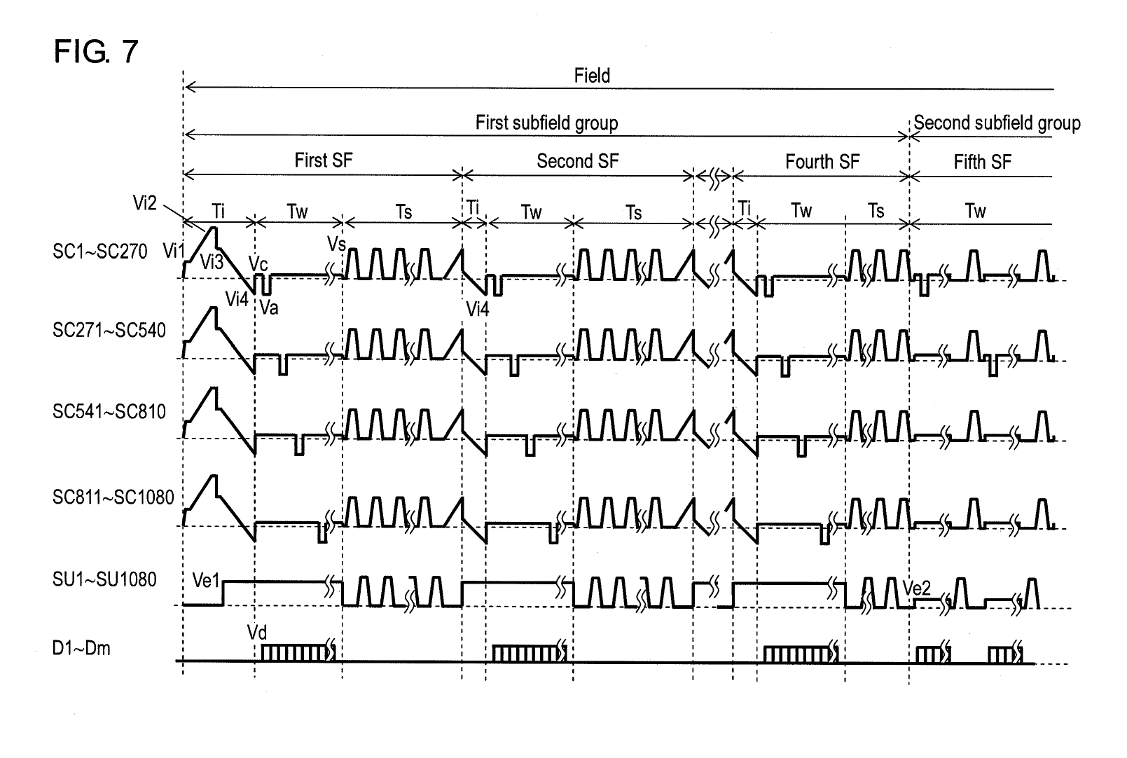

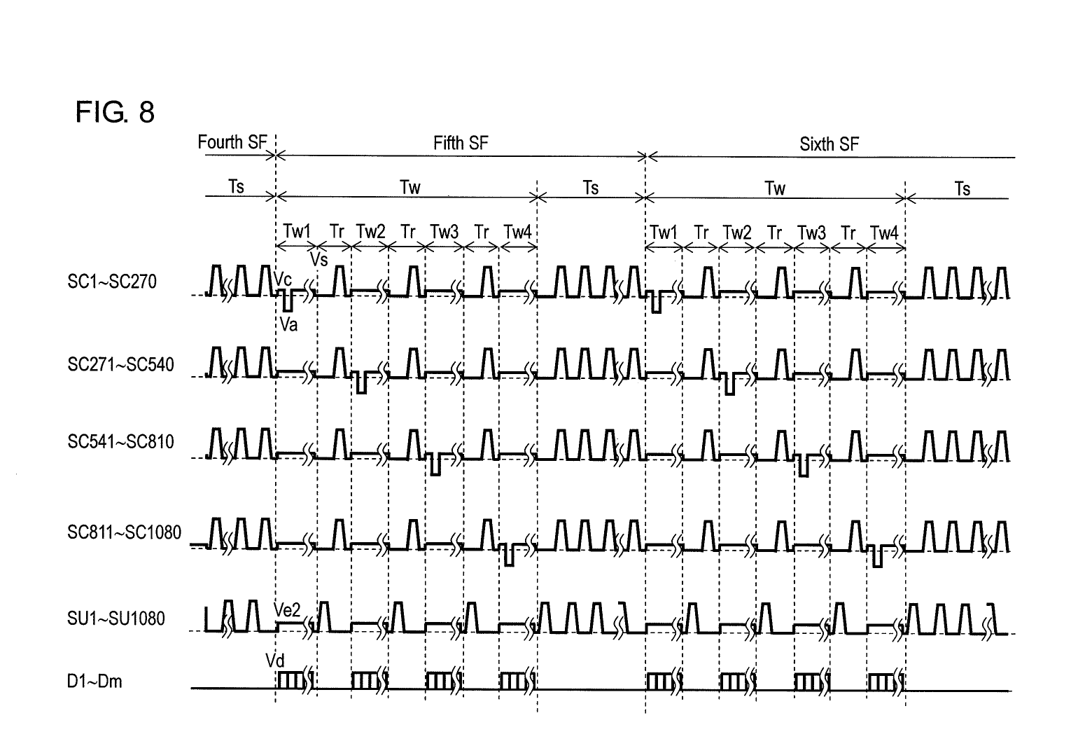

Here will be given details of the panel driving method of the embodiment. FIGS. 7 and 8 are waveform charts of driving voltage to be applied to each electrode of panel 10 of the embodiment of the present invention. Specifically, FIG. 7 mainly shows the waveforms of driving voltage for the first subfield group, whereas FIG. 8 mainly shows the waveforms for the second subfield group.

First will be described the waveforms of driving voltage for the first subfield group.

In the first half of initializing period Ti of the first SF, 0 (V) is applied to data electrodes D1 through Dm and sustain electrodes SU1 through SUn. An up-ramp waveform voltage is applied to scan electrodes SC1 through SCn. The up-ramp waveform voltage gradually increases, starting from voltage Vi1 that is lower than the discharge start voltage with respect to sustain electrodes SU1 through SUn, toward voltage Vi2 that exceeds the discharge start voltage.

During the application of the up-ramp voltage, a weak initializing discharge occurs between scan electrodes SC1 through SCn and sustain electrodes SU1 through SUn, and between scan electrodes SC1 through SCn and data electrodes D1 through Dm. Through the initializing discharge, negative wall voltage is accumulated on scan electrodes SC1 through SCn, and positive wall voltage is accumulated on data electrodes D1 through Dm and sustain electrodes SU1 through SUn. Here, the wall voltage on each electrode represents a voltage generated by wall charge accumulated, for example, on the dielectric layer, on the protective layer, and on the phosphor layer disposed over the electrodes. In the initializing discharge above, an excessive amount of wall charges is accumulated prior to the latter half of the initializing period where wall voltage is optimized to a proper value.

In the latter half of initializing period Ti, voltage Ve1 is applied to sustain electrodes SU1 through SUn. A down-ramp waveform voltage is applied to scan electrodes SC1 through SCn. The down-ramp waveform voltage gradually decreases, starting from voltage Vi3 that is lower than the discharge start voltage with respect to sustain electrodes SU1 through SUn, toward voltage Vi4 that exceeds the discharge start voltage. During the application of voltage, a weak initializing discharge between scan electrodes SC1 through SCn and sustain electrodes SU1 through SUn, and between scan electrodes SC1 through SCn and data electrodes D1 through Dm. Through the discharge, negative wall voltage on scan electrodes SC1 through SCn and positive wall voltage on sustain electrodes SU1 through SUn are weakened; on the other hand, positive wall voltage on data electrodes D1 through Dm is adjusted to a value suitable for the address operation. In this way, the all-cell initializing operation for generating an initializing discharge in all the discharge cells is completed.

In subsequent address period Tw, voltage Ve1 is applied to sustain electrodes SU1 through SUn and voltage Vc is applied to scan electrodes SC1 through SCn.

Next, negative scan pulse voltage Va is applied to scan electrode SC1 located in the first line, and positive address pulse voltage Vd is applied to data electrode Dk (k is 1 through m) that corresponds to the discharge cell to be lit in the first line. At this time, difference in voltage at the intersection of data electrode Dk and scan electrode SC1 is calculated by adding the difference in wall voltage between data electrode Dk and scan electrode SC1 to the difference in voltage applied from outside (i.e., Vd−Va). The calculated value exceeds the discharge start voltage, thereby generating an address discharge between data electrode Dk and scan electrode SC1, and between sustain electrode SU1 and scan electrode SC1. Through the address discharge, positive wall voltage is accumulated on scan electrode SC1 and negative wall voltage is accumulated on sustain electrode SU1 and data electrode Dk.

In the process above, the time that has elapsed since application of scan pulse voltage Va and address pulse voltage Vd before an address discharge is referred to as a “discharge delay time”. For example, if a panel offers poor electron emission and accordingly the discharge delay time of the panel increases, there is a necessity to extend the time required for the application of scan pulse voltage Va and address pulse voltage Vd so as to complete an address operation without failure. That is, the scan pulse and the address pulse need a longer pulse width, increasing the time required for an address operation. Similarly, if a panel offers poor charge retention, there is a necessity to increase each voltage value of scan pulse voltage Va and address pulse voltage Vd so as to compensate for decrease in wall voltage. However, panel 10 of the embodiment offers high electron emission, allowing pulse widths of the scan pulse and the address pulse to be shorter than those in a conventional panel. This contributes to a reliable address operation at high speed. Besides, panel 10 of the embodiment offers high charge retention, allowing voltage values of scan pulse voltage Va and address pulse voltage Vd to be smaller than those in a conventional panel.

As described above, an address discharge is generated in a discharge cell to be lit in the first line, which is the positive-logic address operation for accumulating wall charge necessary for a sustain discharge. On the other hand, the voltage at the intersections of scan electrode SC1 and data electrodes D1 through Dm with no application of address pulse voltage Vd is lower than the discharge start voltage and therefore no address discharge. After the positive-logic address operation is repeatedly carried out until the discharge cells located in the n-th line, address period Tw is completed.

In subsequent sustain period Ts, positive sustain pulse voltage Vs is applied to scan electrodes SC1 through SCn, and at the same time, 0 (V) is applied to sustain electrodes SU1 through SUn. In the discharge cell having undergone the positive-logic address operation, difference in voltage between scan electrode SCi and sustain electrode SUi is calculated by adding sustain pulse voltage Vs to the difference between the wall voltage on scan electrode SCi and the wall voltage on sustain electrode SUi. The calculated value exceeds the discharge start voltage, thereby generating a sustain discharge between scan electrode SCi and sustain electrode SUi. The sustain discharge produces ultraviolet light, allowing phosphor layers 35 to emit light. Negative wall voltage is accumulated on scan electrode SCi and positive wall voltage is accumulated on sustain electrode SUi and data electrode Dk. A discharge cell without the positive-logic address operation in address period Tw has no sustain discharge and therefore maintains the wall voltage the same as that at the end of initializing period Ti.

Next, 0 (V) is applied to scan electrodes SC1 through SCn and sustain pulse voltage Vs is applied to sustain electrodes SU1 through SUn. In the discharge cell having undergone a sustain discharge, difference in voltage between sustain electrode SUi and scan electrode SCi exceeds the discharge start voltage, thereby generating a sustain discharge again between sustain electrode SUi and scan electrode SCi. Through the discharge, negative wall voltage is accumulated on sustain electrode SUi and positive wall voltage is accumulated on scan electrode SCi. In this way, scan electrodes SC1 through SCn and sustain electrodes SU1 through SUn alternately undergo the application of sustain pulses corresponding in number to each luminance weight, providing difference in voltage between the paired electrodes of the display electrode pairs. This allows the sustain discharge to repeatedly occur in a discharge cell having undergone the positive-logic address operation.

At the end of sustain period Ts, a voltage with an up-ramp waveform is applied between scan electrodes SC1 through SCn. The application of voltage erases wall voltage on scan electrode SCi and sustain electrode SUi, with the positive wall voltage on data electrode Dk maintained.

In initializing period Ti of the subsequent second SF, voltage Ve1 is applied to sustain electrodes SU1 through SUn and 0 (V) is applied to data electrodes D1 through Dm. On the other hand, a down-ramp voltage gradually decreasing toward voltage Vi4 is applied to scan electrodes SC1 through SCn. During the application of voltage above, a weak initializing discharge occurs in a discharge cell having undergone a sustain discharge in the immediately preceding subfield. The discharge weakens wall voltage on scan electrode SCi and sustain electrode SUi. The previously generated sustain discharge allows a sufficient amount of positive wall voltage to be maintained on electrode Dk. The surplus of the wall voltage is discharged, so that a proper amount of wall voltage is left for the address operation.

On the other hand, a discharge cell without a sustain discharge in the immediately preceding subfield has no discharge and therefore maintains the wall voltage the same as that at the end of the initializing period of the previous subfield. As described above, the initializing operation in the second SF is the selective initializing operation, which is carried out selectively in a discharge cell having undergone the sustain operation in the sustain period of the immediately preceding subfield.

The operations carried out in subsequent address period Tw are similar to those carried out in address period Tw of the first SF and descriptions thereof will be omitted. The operations of subsequent sustain period Ts are also similar—except for the number of sustain pulses—to those carried out in sustain period Ts of the first SF. The operations carried out in the third SF are also similar—except for the number of sustain pulses—to those carried out in the second SF. Further, the operations carried out in initializing period Ti and address period Tw of the fourth SF are similar to those carried out in the second SF.

In sustain period Ts of the fourth SF, as in sustain period Ts of the first SF through the third SF, sustain pulses corresponding in number to each luminance weight are alternately applied to the display electrode pairs so that a potential difference is provided between the electrodes of the display electrode pairs. As a result, a sustain discharge is repeatedly generated in a discharge cell having undergone the positive-logic address operation.

At the end of sustain period Ts of the fourth SF, sustain pulse voltage Vs is applied to scan electrodes SC1 through SCn and 0 (V) is applied to sustain electrodes SU1 through SUn. The application of voltage allows a sustain discharge to be generated in a discharge cell having undergone an address discharge. Through the discharge, negative wall voltage is accumulated on scan electrode SCi and positive wall voltage is accumulated on sustain electrode SUi and data electrode Dk. Sustain period Ts of the fourth SF is thus completed.

As described above, on the completion of sustain period Ts of the last subfield of the first subfield group, negative wall voltage remains on scan electrode SCi and positive wall voltage remains on sustain electrode SUi without being erased. The wall voltage is used for generating a sustain discharge in the subfields of the second subfield group.

On the other hand, no wall voltage is accumulated on scan electrode SCi and sustain electrode SUi disposed at a discharge cell where no sustain discharge has occurred in the fourth SF. Therefore, in the discharge cell where no sustain discharge has occurred in the fourth SF, no sustain discharge occur in the subsequent fifth SF through the 11th SF of the second subfield group.

Next, the waveforms of driving voltage used for the subfields of the second subfield group will be described with reference to FIG. 8. In the subfields of the second subfield group, address period Tw is divided into four address sub-periods (first period Tw1, second period Tw2, third period Tw3, and fourth period Tw4) so as to correspond to the four display electrode pair groups. In addition, replenish sub-period Tr for replenishing wall charge is disposed between an address sub-period and the subsequent address sub-period.

In first period Tw1 of address period Tw of the fifth SF, voltage Ve2 is applied to sustain electrodes SU1 through SUn and voltage Vc is applied to scan electrodes SC1 through SCn. Further, scan pulse voltage Va is applied to scan electrode SC1 located in the first line, and address pulse voltage Vd is applied to data electrode Dh (h is 1 through m) that corresponds to the discharge cell to be unlit in data electrodes D1 through Dm in the first line. Through the application of voltage, an address discharge is generated between data electrode Dh and scan electrode SC1 and between sustain electrode SU1 and scan electrode SC1, by which each wall voltage on scan electrode SC1 and on sustain electrode SU1 is erased. Erasing wall voltage means that wall voltage is weakened to a level at which a sustain discharge is not generated in the sustain period described later.

The negative-logic address operation above is repeatedly carried out until the discharge cells located in the 270th line of the first display electrode pair group. The discharge delay time in the negative-logic address operation is small, allowing pulse widths of the scan pulse and the address pulse to be set shorter than those in a conventional panel. This contributes to a reliable address operation at high speed.

In subsequent replenish sub-period Tr, first, 0 (V) is applied to scan electrodes SC1 through SCn, and sustain pulse voltage Vs is applied to sustain electrodes SU1 through SUn. Through the application of voltage, a discharge is generated between scan electrode SCi and sustain electrode SUi disposed at a discharge cell where a sustain discharge has occurred in the immediately preceding fourth SF and a negative-logic address operation has not been carried out in first period Tw1 of the fifth SF. The discharge generated in replenish sub-period Tr (hereinafter, replenish discharge), which is similar to the sustain discharge, replenishes positive wall charge on a data electrode disposed at a discharge cell that has the replenish discharge. Next, sustain pulse voltage Vs is applied to scan electrodes SC1 through SCn and 0 (V) is applied to sustain electrodes SU1 through SUn. Through application of voltage, a replenish discharge is generated again between scan electrode SCi and sustain electrode SUi.

In subsequent second period Tw2, the discharge cells located in the 271st lines through 540th lines of the second display electrode pair group carry out the negative-logic address operation. In subsequent replenish sub-period Tr, a replenish discharge is generated to replenish wall charge on the data electrodes. In subsequent third period Tw3, the discharge cells located in the 541st lines through 810th lines of the third display electrode pair group undergo the negative-logic address operation. In subsequent replenish sub-period Tr, a replenish discharge is generated to replenish wall charge. In subsequent fourth period Tw4, the discharge cells located in the 811th lines through 1080th lines of the fourth display electrode pair group undergo the negative-logic address operation. In this way, address period Tw of the fifth SF is completed.

According to the embodiment, it has been shown that wall charge decreases by the negative-logic address operation even in a panel with high charge retention like panel 10. Suppose that the negative-logic address operation is successively carried out for n lines without replenish sub-period Tr. In that case, because of decrease in wall voltage caused by decrease in wall charge, there is a necessity to increase scan pulse voltage Va and address pulse voltage Vd. In the embodiment, however, wall charge on the data electrodes is increased by replenish sub-period Tr disposed every negative-logic address operation for one-fourth lines. This prevents significant decrease in wall charge, allowing scan pulse voltage Va and address pulse voltage Vd to be set low.

In subsequent sustain period Ts, first, 0 (V) is applied to scan electrodes SC1 through SCn and sustain pulse voltage Vs is applied to sustain electrodes SU1 through SUn. Through the application of voltage, a sustain discharge is generated in a discharge cell where a sustain discharge has occurred and a negative-logic address operation has not been carried out in the immediately preceding subfield, by which the discharge cell emits light. Through the discharge, positive wall voltage is accumulated on scan electrode SCi and negative wall voltage is accumulated on sustain electrode SUi. On the other hand, in a discharge cell with no sustain discharge in the immediately preceding subfield or in a discharge cell having a negative-logic address operation in the address period, no sustain discharge is generated.

Next, sustain pulse voltage Vs is applied to scan electrodes SC1 through SCn and 0 (V) is applied to sustain electrodes SU1 through SUn. In the discharge cell having undergone a sustain discharge, difference in voltage between scan electrode SCi and sustain electrode SUi exceeds the discharge start voltage, thereby generating again a sustain discharge. Through the discharge, negative wall voltage is accumulated on scan electrode SCi and positive wall voltage is accumulated on sustain electrode SUi.

In this way, sustain electrodes SU1 through SUn and scan electrodes SC1 through SCn alternately undergo sustain pulses corresponding in number to each luminance weight, providing difference in voltage between the paired electrodes of the display electrode pairs. This allows the sustain discharge to repeatedly occur in a discharge cell with no address discharge in the address period.

The operations carried out in the subsequent sixth SF through the 11th SF are similar—except for the number of sustain pulses—to those carried out in the fifth SF.

According to the embodiment, the values of voltage applied to each electrode are determined as follows. As for scan electrodes SC1 through SCn, 120 (V) for voltage Vi1, 350 (V) for voltage Vi2, 210 (V) for voltage Vi3, −105 (V) for voltage Vi4, 0 (V) for voltage Vc, −120 (V) for voltage Va, and 210 (V) for voltage Vs. As for sustain electrodes SU1 through SUn, −140 (V) for voltage Ve1, 50 (V) for voltage Ve2, and 210 (V) for voltage Vs. As for data electrodes D1 through Dm, 60 (V) for voltage Vd. The voltage with an up-ramp waveform applied to scan electrodes SC1 through SCn has a gradient of 1.0 V/μ and the voltage with a down-ramp waveform has a gradient of −1.3 V/μ. Both the scan pulse and the address pulse have a pulse width of 1.0 μs. The aforementioned values are cited merely by way of example and without limitation. They should be optimally determined according to characteristics of a panel and specifications of a plasma display device.

As described earlier, protective layer 26 of panel 10 of the embodiment is formed of base protective layer 26a of a thin film containing magnesium oxide and particle layer 26b in which magnesium-oxide single-crystal particles 27 are stuck to base protective layer 26a. Single-crystal particle 27 has an NaCl crystal structure surrounded by the specified two-type orientation face of (100) and (111) faces or an NaCl crystal structure surrounded by the specified three-type orientation face of (100), (110), and (111) faces. With the structure above, panel 10 offers excellent performance of electron emission and charge retention. According to the driving circuit of the panel, a plurality of subfields, which form one field period, is divided into two subfield groups: the first subfield group and the second subfield group. The second subfield group is disposed temporally behind the first subfield group. Each subfield of the first subfield group has an initializing period for forming wall charge to generate an address discharge, an address period for forming wall charge to generate a sustain discharge, and a sustain period for generating a sustain discharge so that a discharge cell emits light. Throughout the first subfield group, the random driving with the use of the positive-logic address operation is carried out. On the other hand, each subfield of the second subfield group has an address period for erasing wall charge necessary for generating a sustain discharge and a sustain period for generating a sustain discharge so that a discharge cell emits light. Throughout the second subfield group, the successive driving with the use of the negative-logic address operation is carried out.

According to the embodiment, with high performance of electron emission and high-speed driving of panel 10, an address period is shortened and the number of subfields of the second subfield group driven on the successive driving is sufficiently provided. With the structure, panel 10 offers image display without false contours. Besides, by virtue of a combined use of the first subfield group driven on the random driving together with the second subfield group, panel 10 achieves smooth gradation display. In addition, in each subfield of the second subfield group, the address period is divided into a plurality of address sub-periods so as to correspond to a plurality of display electrode pair groups, and further, a replenish sub-period is disposed between an address sub-period and the subsequent address sub-period so that wall charge is increased therebetween. This allows scan pulse voltage Va and address pulse voltage Vd to be set low.

In the embodiment, the description has been given under the following conditions: one field period is divided into 11 subfields (the first SF, the second SF, . . . , the 11th SF) and each of which has respective luminance weight (8, 4, 2, 1, 16, 20, 26, 32, 40, 48, 58). The first subfield group of the first SF through the fourth SF carries out the random driving with the use of the positive-logic address operation, while the second subfield group of the fifth SF through the 11th SF carries out the successive driving with the use of the negative-logic address operation. However, the subfield structure, such as the number of subfields and luminance weight, is not limited to the above. They should be optimally determined according to characteristics of a panel and specifications of a plasma display device.

Besides, in the description of the embodiment, the display electrode pairs undergo the application of sustain pulses in a sustain period of each subfield. However, a subfield having a sustain period with no application of sustain pulses may be disposed. In the sustain period in that case, sustain pulse voltage Vs is applied to scan electrodes SC1 through SCn and 0 (V) is applied to sustain electrodes SU1 through SUn without the application of sustain pulses to the display electrode pairs. Through the application of voltage, wall voltage is erased in a discharge cell having undergone an address discharge. This allows a dark image to have smooth image display.

Although, in the description, the subfields of the first subfield group are disposed in a manner that luminance weight thereof has a monotonous decrease, it is not limited to. However, the inventors have demonstrated that the arrangement of subfields with monotonous decrease in luminance weight allows discharge delay time at an address discharge to be shortened. Next will be described a driving circuit for generating the driving voltage waveforms described in the embodiment.

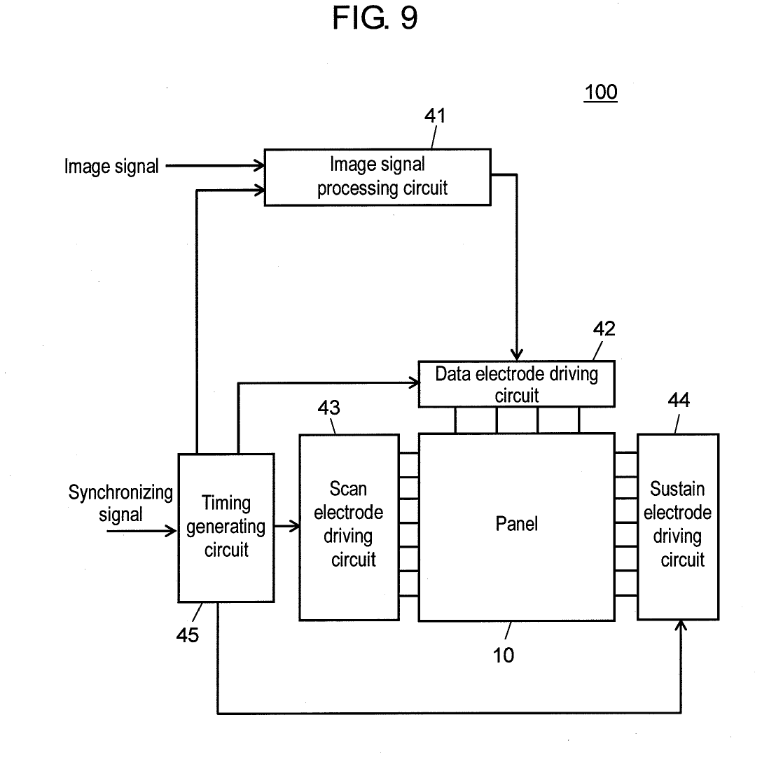

FIG. 9 is a circuit block diagram of plasma display device 100 of the embodiment. Plasma display device 100 has panel 10 and a panel driving circuit. The panel driving circuit has image signal processing circuit 41, data electrode driving circuit 42, scan electrode driving circuit 43, sustain electrode driving circuit 44, timing generating circuit 45, and a power supply circuit (not shown) for supplying power to each circuit block.

Receiving an image signal, image signal processing circuit 41 converts it into image data for light-emitting or non-light-emitting on a subfield basis. Data electrode driving circuit 42 converts the image data of each subfield into a signal for data electrodes D1 through Dm to drive them. Timing generating circuit 45 generates timing signals that control each circuit block according to a horizontal synchronizing signal and a vertical synchronizing signal. Such generated timing signals are fed to each circuit block. According to the timing signals, scan electrode driving circuit 43 drives scan electrodes SC1 through SCn. According to the timing signals, sustain electrode driving circuit 44 drives sustain electrodes SU1 through SUn.

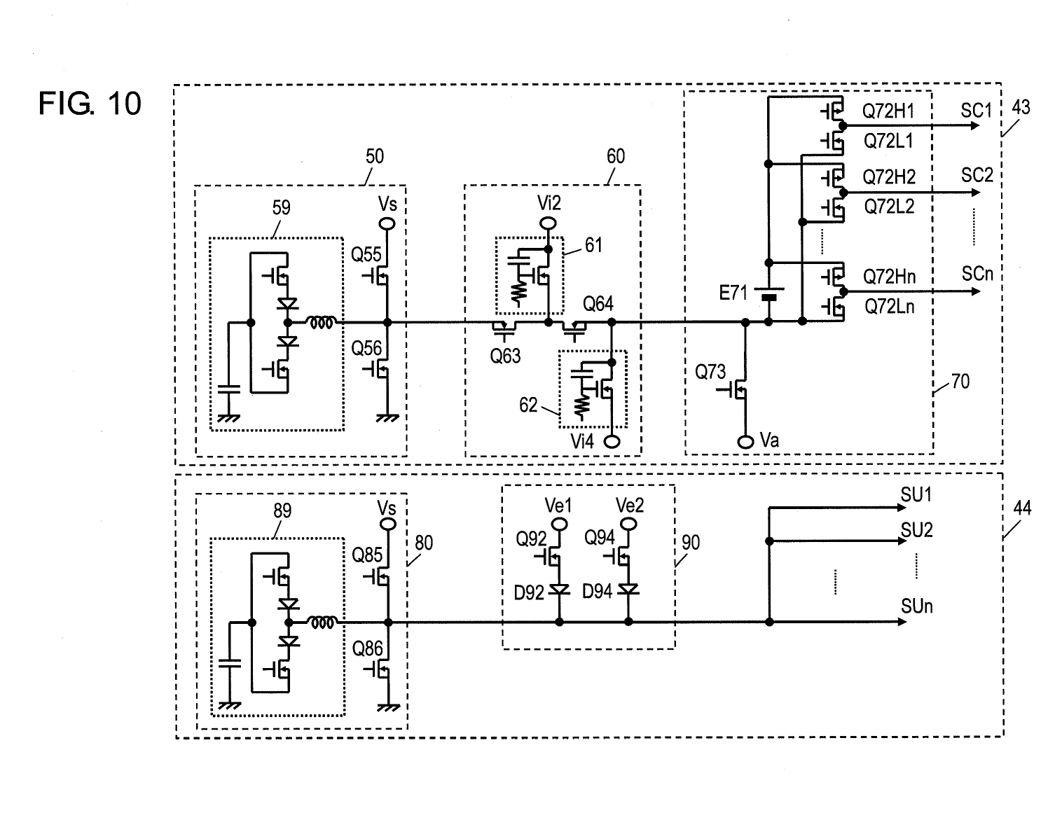

FIG. 10 is a circuit diagram showing scan electrode driving circuit 43 and sustain electrode driving circuit 44 of plasma display device 100 of the embodiment of the present invention.

Scan electrode driving circuit 43 has sustain pulse generating circuit 50, initializing waveform generating circuit 60, and scan-pulse generating circuit 70. Sustain pulse generating circuit 50 has switching element Q55 for applying voltage Vs to scan electrodes SC1 through SCn, switching element Q56 for applying 0 (V) to scan electrodes SC1 through SCn, and power recovering section 59 for recovering power for the application of sustain pulses to scan electrodes SC1 through SCn. Initializing waveform generating circuit 60 has Miller integrating circuit 61 and Miller integrating circuit 62. Miller integrating circuit 61 applies voltage having up-ramp waveform to scan electrodes SC1 through SCn, whereas Miller integrating circuit 62 applies voltage having down-ramp waveform to scan electrodes SC1 through SCn. Switching elements Q63, Q64 prevent backflow of electric current via a parasitic diode of other switching elements. Scan-pulse generating circuit 70 has floating power supply E71, switching elements Q72H1 through Q72Hn and Q72L1 through Q72Ln, and switching element Q73. Switching elements Q72H1 through Q72Hn apply voltage on the high-voltage side of floating power supply E71 to scan electrodes SC1 through SCn, whereas switching elements Q72L1 through Q72Ln apply voltage on the low-voltage side of floating power supply E71 to scan electrodes SC1 through SCn. Switching element Q73 fixes voltage on the low-voltage side of floating power supply E71 to voltage Va.

Sustain electrode driving circuit 44 has sustain pulse generating circuit 80 and initializing/address voltage generating circuit 90. Sustain pulse generating circuit 80 has switching element Q85 for applying voltage Vs to sustain electrodes SU1 through SUn, switching element Q86 for applying 0 (V) to sustain electrodes SU1 through SUn, and power recovering section 89 for recovering power for the application of sustain pulses to sustain electrodes SU1 through SUn. Initializing/address voltage generating circuit 90 has switching element Q92 and diode D92 for applying voltage Ve1 to sustain electrodes SU1 through SUn, switching element Q94 and diode D94 for applying voltage Ve2 to sustain electrodes SU1 through SUn.

The switching elements above are formed of generally well-known devices, such as a metal oxide semiconductor field-effect transistor (MOSFET) and an insulated gate bipolar transistor (IGBT). The switching elements are controlled by each of timing signals generated in timing generating circuit 45.

The driving circuit of FIG. 10 is introduced as an example for generating the driving voltage waveforms shown in FIG. 7 and FIG. 8. The plasma display device of the present invention does not necessarily have the circuit structure.

Besides, specific values seen throughout the description of the embodiment are cited merely by way of example and without limitation. They should be optimally determined according to characteristics of a panel and specifications of a plasma display device.

### INDUSTRIAL APPLICABILITY

The plasma display device of the present invention offers stable address operation at high speed and excellent image having smooth gradation display without false contours. The plasma display device capable of showing high quality image is greatly useful for a display device.

1. A plasma display device comprising:
a plasma display panel including:
a front plate having display electrode pairs on a first glass substrate, a dielectric layer disposed so as to cover the display electrode pairs, and a protective layer disposed on the dielectric layer;
a back plate having data electrodes on a second glass substrate, the back plate being disposed opposite to the front plate; and
discharge cells formed at intersecting positions of the display electrode pairs and the data electrodes; and
a panel driving circuit for driving the plasma display panel in a manner that a plurality of subfields are temporally disposed to form one field period,
wherein the protective layer has
a base protective layer formed of a thin film of metal oxide containing at least one of magnesium oxide, strontium oxide, calcium oxide, and barium oxide; and
a particle layer formed in a manner that single-crystal particles of magnesium oxide having an NaCl crystal structure surrounded by one of a specified two-type orientation face formed of (100) face and (111) face and a specified three-type orientation face formed of (100) face, (110) face, and (111) face are stuck on the base protective layer, and
wherein the panel driving circuit drives the plasma display panel in a manner that one field period is formed of a first subfield group having a plurality of subfields and a second subfield group having a plurality of subfields temporally disposed after the first subfield group, each subfield of the first subfield group has an initializing period for forming wall charge to generate an address discharge, an address period for forming wall charge to generate a sustain discharge, and a sustain period for generating a sustain discharge so that the discharge cells emit light, each subfield of the second subfield group has an address period for erasing wall charge necessary for generating a sustain discharge and a sustain period for generating a sustain discharge so that the discharge cells emit light.

2. The plasma display device of claim 1,
wherein the panel driving circuit drives the plasma display panel in a manner that the display electrode pairs are divided into a plurality of display electrode pair groups, the address period of each subfield of the second subfield group is divided into a plurality of address sub-periods so as to correspond to the plurality of display electrode pair groups, and a replenish sub-period for supplying wall charge is disposed between an address sub-period and the subsequent address sub-period.
